(19) United States
(12) Patent Application Publication
(10) Pub. No.: US 2017/0287117 A1
(43) Pub. Date: Oct. 5, 2017

(54) SYSTEM FOR IMAGE CORRECTION PROCESSING

(71) Applicant: NIKON CORPORATION, Tokyo (JP)

(72) Inventor: Shinya EBIHARA, Kawasaki-shi (JP)

(73) Assignee: NIKON CORPORATION, Tokyo (JP)

(21) Appl. No.: 15/631,350

(22) Filed: Jun. 23, 2017

Related U.S. Application Data
(63) Continuation of application No. 13/805,213, filed on Dec. 18, 2012, now abandoned.

(30) Foreign Application Priority Data
Jul. 5, 2010 (JP) 2010-152923
Mar. 7, 2011 (JP) 2011-049316
Jun. 30, 2011 (JP) 2011-145919

(51) Int. Cl. G06T 5/00

(52) U.S. Cl. CPC G06T 5/002; G06T 5/003; G06T 2207/10024; G06T 2207/20012

(57) ABSTRACT

An image smoothing unit smoothing a target image having pixel values which include a plurality of color components with a different plurality of smoothing degrees and generating a plurality of smoothed images; a calculation unit obtaining color differences being differences between a pixel value of a predetermined color component of the target image and pixel values of a color component of each of the smoothed images which is different from the predetermined color component at each pixel position of the target image, and calculating dispersions of the obtained color difference; a determination unit comparing sharpness of each of the color components of the target image based on the dispersions of the color differences and determining a color component having the highest sharpness; and an adjustment unit adjusting the sharpness of at least one of the color components of the target image based on the color component having the highest sharpness.

### CROSS REFERENCE TO RELATED APPLICATIONS

This application is a continuation of U.S. application Ser. No. 13/805,213 filed Dec. 18, 2012, which in turn is a U.S. National Stage application claiming the benefit of prior filed International Application Number PCT/JP2011/003813, filed Jul. 4, 2011, in which the International application claims priorities from Japanese Application Numbers 2010-152923 (filed on Jul. 5, 2010), 2011-049316 (filed on Mar. 7, 2011), and 2011-145919 (filed on Jun. 30, 2011), the contents of which are incorporated herein by reference.

### TECHNICAL FIELD

The present application relates to an image processing device, an imaging device, and an image processing program.

### BACKGROUND ART

Conventionally, an image of a subject image-formed and image-captured by an optical system such as an imaging lens is affected by a chromatic aberration, in particular, an axial chromatic aberration caused by the optical system.

For example, an art has been developed in which mismatching of MTF characteristics between respective color components are adjusted such that a color plane of one color component to be a reference is smoothed to minimize a color difference with a color plane of the other color component to thereby correct the axial chromatic aberration to solve the above-stated problem (refer to Patent Document 1).
Patent Document 1: Japanese Unexamined Patent Application Publication No. 2007-28041

### DISCLOSURE

### Problems to be Solved

However, there is a case when the color difference behaves unpredictably if a smoothing degree becomes large when the smoothing of the color plane of the color component to be the reference is performed such that the color difference with the color plane of the other color component becomes minimum.

Besides, there is a problem in which saturation becomes small and color loss occurs when the above-stated correction is applied for a color structure part of an image other than the effect of the axial chromatic aberration. Otherwise, there is a case when a color change occurs at the color structure part of the image other than the effect of the axial chromatic aberration.

In consideration of the problems held by the above-stated conventional art, a proposition of the present application is to provide an art capable of correcting the axial chromatic aberration with high accuracy without generating the color loss and so on.

### Means for Solving the Problems

To solve the above-stated problems, an aspect of an image processing device according to the present embodiment includes an image smoothing unit smoothing a target image having pixel values which include a plurality of color components with a different plurality of smoothing degrees and generating a plurality of smoothed images; a calculation unit obtaining, at each pixel position of the target image, color differences being differences between a pixel value of a predetermined color component of the target image and pixel values of a color component of the smoothed image in which the color component is different from the predetermined color component, and calculating dispersions of the color differences being obtained; a determination unit comparing sharpness of each of the color components of the target image based on the dispersions of the color differences and determining a color component having the highest sharpness; and an adjustment unit adjusting the sharpness of at least one of the color components of the target image based on the color component having the highest sharpness.

Besides, the calculation unit may calculate the dispersions of the color differences by using pixel values of the predetermined color component and pixel values of the color component different from the predetermined color component in a first region centering on a position of a pixel to be processed of the target image and each of the smoothed images.

Besides, a judgment unit judging whether or not there is a color boundary which is a difference between a color structure of the predetermined color component and a color structure of the color component different from the predetermined color component in a second region centering on the position of the pixel to be processed of the target image is further included, in which the calculation unit may calculate the dispersions of the color differences by matching a distribution width of pixel values of the predetermined color component and a distribution width of pixel values of the color component different from the predetermined color component with each other in the second region of the target image and each of the smoothed images when judged by the judgment unit that there is the color boundary.

Besides, the determination unit may determine a color component giving a minimum dispersion value among the dispersions of the color differences of the smoothed images as the color component having the highest sharpness at each pixel.

Besides, the determination unit may determine the minimum dispersion value based on an interpolation method.

Another aspect of an image processing device according to the present embodiment includes an image smoothing unit smoothing a target image having pixel values which includes a plurality of color components with a different plurality of smoothing degrees and generating a plurality of smoothed images; a calculation unit obtaining, at each pixel position of the target image, color differences being differences between a pixel value of a predetermined color component of the target image and pixel values of a color component of each of the smoothed images in which the color component is different from the predetermined color component, and calculating dispersions of the color differences in accordance with the smoothing degrees; a judgment unit judging whether or not each pixel position is on a color boundary based on the dispersions of the color differences; a determination unit setting a pixel at the pixel position being judged not to be on the color boundary as a target pixel, comparing sharpness of each of the color components based on the dispersions of the color differences, and determining a color component having the highest sharpness; and an adjustment unit adjusting the sharpness of at least one of the color components of the target pixel based on the color component having the highest sharpness.

Besides, the calculation unit may obtain the color differences as absolute values of the differences.

Besides, the judgment unit may judge whether or not the color boundary is a color bleeding caused by a concentration difference at a periphery of saturated region based on a distribution of the pixel values of each of the color components, and the determination unit may set a pixel at the pixel position being judged to be on the color boundary as the target pixel when the color boundary is judged to be the color bleeding.

Besides, a color correction unit correcting a pixel value of the target pixel being adjusted the sharpness to be identical to a direction of a color difference of a pixel value before being adjusted the sharpness may further be included.

Besides, the color correction unit may reduce a size of a color difference component of the pixel value of the target pixel being adjusted the sharpness when the size of the color difference component of the pixel value of the target pixel being adjusted the sharpness is a predetermined size or more in the color difference space.

Besides, the calculation unit may calculate the dispersions of the color differences by using pixel values of the predetermined color component of the target image and pixel values of the color component of each of the smoothed images which the color component is different from the predetermined color component in a region centering on the pixel position.

Besides, the determination unit may determine, at the target pixel, a component giving a minimum dispersion value by each of the color differences of the smoothed images as the color component of which sharpness is high, and determines a color component having the highest sharpness by comparing the sharpness of the color component being determined.

Besides, the calculation unit may determine the minimum dispersion value based on an interpolation method.

An aspect of an imaging device according to the present embodiment includes an imaging unit image-capturing a subject and generating a target image having pixel values of a plurality of color components, and the image processing device according to the present embodiment.

An aspect of an image processing program according to the present embodiment causes a computer to execute an input step reading a target image having pixel values of a plurality of color components; an image smoothing step smoothing the target image with a different plurality of smoothing degrees and generating a plurality of smoothed images; a calculation step obtaining, at each pixel position of the target image, color differences being differences between a pixel value of a predetermined color component of the target image and pixel values of a color component of each of the smoothed images in which the color component is different from the predetermined color component, and calculating dispersions of the color differences being obtained; a determination step comparing sharpness of each of the color components of the target image based on the dispersions of the color differences, and determining a color component having the highest sharpness; and an adjustment step adjusting the sharpness of at least one of the color components of the target image based on the color component having the highest sharpness.

An aspect of an image processing program according to the present embodiment causes a computer to execute an input step reading a target image having pixel values of a plurality of color components; an image smoothing step smoothing the target image with a different plurality of smoothing degrees and generating a plurality of smoothed images; a calculation step obtaining, at each pixel position of the target image, color differences being differences between a pixel value of a predetermined color component of the target image and pixel values of a color component of each of the smoothed images in which the color component is different from the predetermined color component, and calculating dispersions of the color differences in accordance with the smoothing degrees; a judgment step judging whether or not each pixel position is on a color boundary based on the dispersions of the color differences; a determination step setting a pixel at the pixel position being judged not to be on the color boundary as a target pixel, comparing sharpness of each of the color components based on the dispersions of the color differences, and determining a color component having the highest sharpness; and an adjustment step adjusting the sharpness of at least one of the color components of the target pixel based on the color component having the highest sharpness.

According to the present embodiment, it is possible to correct the axial chromatic aberration with high accuracy without generating the color loss and so on.

### BRIEF DESCRIPTION OF THE DRAWINGS

FIG. 1 is a block diagram illustrating a configuration of a computer 10 operated as an image processing device according to a first embodiment.

FIG. 2 is a flowchart illustrating operations of image processing by the computer 10 according to the first embodiment.

FIG. 3 is a view illustrating a relationship between a target pixel and a reference region.

FIG. 4 is a view representing a distribution of a standard deviation DEVr [k′] at the target pixel.

FIG. 5 is a flowchart illustrating operations of image processing by a computer 10 according to a second embodiment.

FIG. 6 is a block diagram illustrating a configuration of a CPU 1 in the computer 10 of the second embodiment.

FIG. 7 is a view describing a difference between a color structure and a color boundary.

FIG. 8 is a view describing a level correction.

FIG. 9 is a block diagram illustrating a configuration of a CPU 1 in a computer 10 according to a third embodiment.

FIG. 10 is a view describing purple fringing.

FIG. 11 is a flowchart illustrating operations of image processing by the computer 10 according to the third embodiment.

FIG. 12 is a flowchart illustrating operations of image processing by a computer 10 according to a fourth embodiment.

FIG. 13 is a view illustrating an example of a configuration of a digital camera according to the present application.

FIG. 14 is a view illustrating another example of a configuration of the digital camera according to the present application.

FIG. 15 is a view illustrating a correction output factor in accordance with a size of a color difference component after correction.

### DETAILED DESCRIPTION OF THE EMBODIMENTS

### First Embodiment

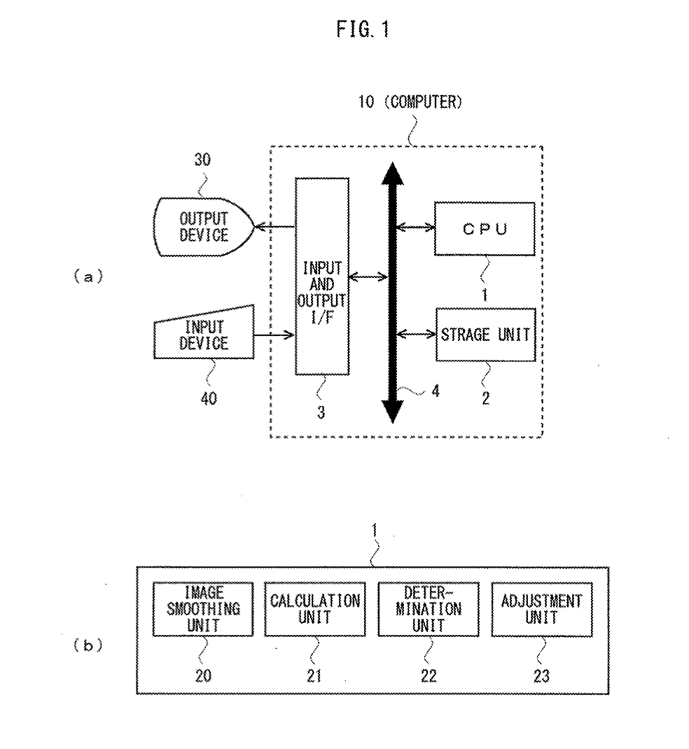

FIG. 1 is a block diagram illustrating a configuration of a computer 10 operated as an image processing device according to a first embodiment of the present invention. A target image processed by the computer 10 assumes to have a pixel value of each of color components of red (R), green (G) and blue (B) in each pixel. Namely, the target image of the present embodiment is an image image-captured by a three-chip color digital camera or image-captured by a one-chip color digital camera and color correction processing is performed thereto. Besides, the target image has an effect of an axial chromatic aberration caused by an imaging lens at an image-capturing time by a digital camera and so on, and sharpness between color components are different.

The computer 10 illustrated in FIG. 1(a) is made up of a CPU 1, a storage unit 2, an input and output interface (input and output I/F) 3 and a bus 4. The CPU 1, the storage unit 2 and the input and output I/F 3 are coupled to be capable of communicating via the bus 4. Besides, an output device 30 displaying an interim process and a process result of image processing, and an input device 40 receiving an input from a user are each coupled to the computer 10 via the input and output I/F 3. A general liquid crystal monitor, printer, and so on can be used for the output device 30, and a keyboard, mouse, and so on can be each appropriately selected to be used for the input device 40.

The CPU 1 is a processor totally controlling each part of the computer 10. For example, the CPU 1 reads an image processing program stored at the storage unit 2 based on an instruction from the user received at the input device 40. The CPU 1 operates as an image smoothing unit 20, a calculation unit 21, a determination unit 22, and an adjustment unit 23 (FIG. 1(b)) by execution of the image processing program, and performs correction processing of the axial chromatic aberration of the target image stored at the storage unit 2. The CPU 1 displays a result of the image processing of the image on the output device 30.

The image smoothing unit 20 uses, for example, N pieces of publicly known Gaussian filters of which smoothing degrees (blur indexes) are different, and generates N pieces of smoothed images in which a target image is smoothed in accordance with the blur indexes of the respective Gaussian filters (N is a natural number of two or more). Note that the blur index in the present embodiment means, for example, a size of a blur radius.

The calculation unit 21 calculates values of a color difference plane (color difference) being a difference between the respective color components and a standard deviation (dispersion) thereof by using the target image and the N pieces of smoothed images as described later. The calculation unit 21 finds the blur index giving a minimum standard deviation by applying a publicly known interpolation method for a distribution of the standard deviation.

The determination unit 22 determines a color component having the highest sharpness based on the blur index giving the minimum standard deviation.

The adjustment unit 23 adjusts the sharpness between the color components based on the color component having the highest sharpness determined by the determination unit 22.

The storage unit 2 records the image processing program and so on to correct the axial chromatic aberration at the target image together with the target image being a captured image of an image-captured subject. The captured image, the program, and so on stored at the storage unit 2 are able to be appropriately referred to from the CPU 1 via the bus 4. A general storage device such as a hard disk device and a magnetic optical disk can be selected and used for the storage unit 2. Note that the storage unit 2 is incorporated in the computer 10, but it may be an external storage device. In this case, the storage unit 2 is coupled to the computer 10 via the input and output I/F 3.

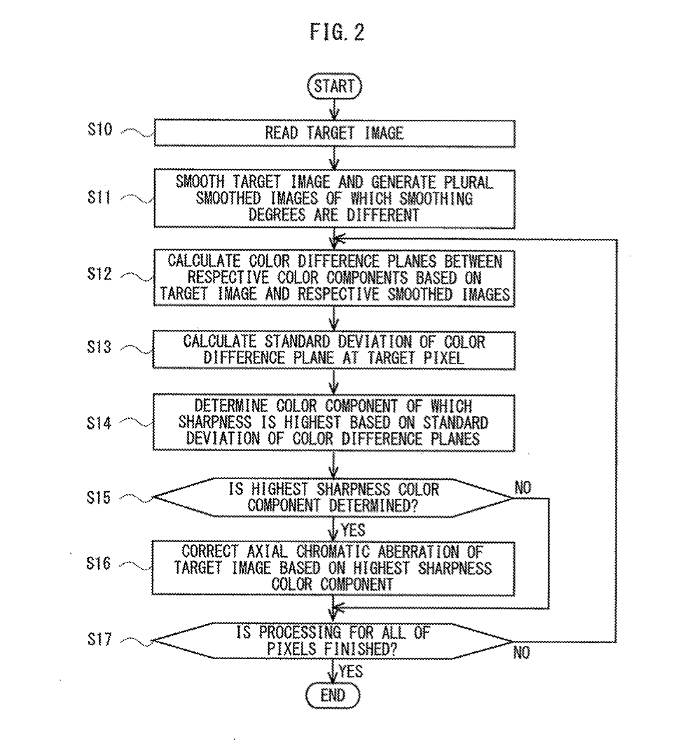

Next, operations of the image processing by the computer 10 according to the present embodiment are described with reference to a flowchart illustrated in FIG. 2.

The user outputs a start instruction of the image processing program to the CPU 1 by inputting a command of the image processing program by using the input device 40, double clicking an icon of the program displayed on the output device 30, or the like. The CPU 1 receives the instruction via the input and output I/F 3, reads and executes the image processing program stored at the storage unit 2. The CPU 1 starts processes from step S10 to step S17 in FIG. 2.

Step S10: The CPU 1 reads a target image being a correction object specified by the user via the input device 40.

Step S11: The image smoothing unit 20 of the CPU 1 smooths the read target image in accordance with the blur index of each Gaussian filter, and generates the N pieces of smoothed images. Note that the total number of smoothed images in the present embodiment is (N+1) pieces because the target image in itself is regarded as one of the smoothed images.

Step S12: The calculation unit 21 of the CPU 1 calculates a color difference plane Cr between an R component and a G component, a color difference plane Cb between a B component and the G component, and a color difference plane Crb between the R component and the B component by using the target image and respective smoothed images.

For example, the calculation unit 21 finds a difference between a pixel value G0 (i, j) of the G component being a predetermined color component of the target image and a pixel value Rk (i, j) of the R component of the smoothed image being a color component different from the above-stated predetermined color component and calculates a color difference plane Cr [−K] (i, j) represented in the following expression (1).

Cr[−k](i,j)=Rk(i,j)−G0(i,j) (1)

Here, the (i, j) represents a coordinate of a pixel position of a target pixel being a pixel of a process object. The “k” is a blur index of the smoothed image, and an integer of “0” (zero)≦k≦N. Note that in the expression (1), the blur index k is minus because it is the color difference plane Cr in which an R plane is sequentially blurred into a minus side. Besides, the blur index k=“0” (zero) represents the target image in itself, namely, the image which is not smoothed.

Similarly, the calculation unit 21 finds a difference between a pixel value R0 (i, j) of the R component being a predetermined color component of the target image and a pixel value Gk (i, j) of the G component of the smoothed image being a color component different from the predetermined color component, and calculates a color difference plane Cr [k] (i, j) of a following expression (2).

Cr[k](i,j)=R0(i,j)−Gk(i,j) (2)

Note that a state in which the blur index k is plus represents that the color difference plane Cr is the one in which the G plane is sequentially blurred into a plus side.

Similarly, the calculation unit 21 calculates each of the color difference plane Cb between the B component and the G component and the color difference plane Crb between the R component and the B component based on an expression (3) to an expression (6).

Cb[−k](i,j)=Bk(i,j)−G0(i,j) (3)

Cb[k](i,j)=B0(i,j)−Gk(i,j) (4)

Crb[−k](i,j)=Rk(i,j)−B0(i,j) (5)

Crb[k](i,j)=R0(i,j)−Bk(i,j) (6)

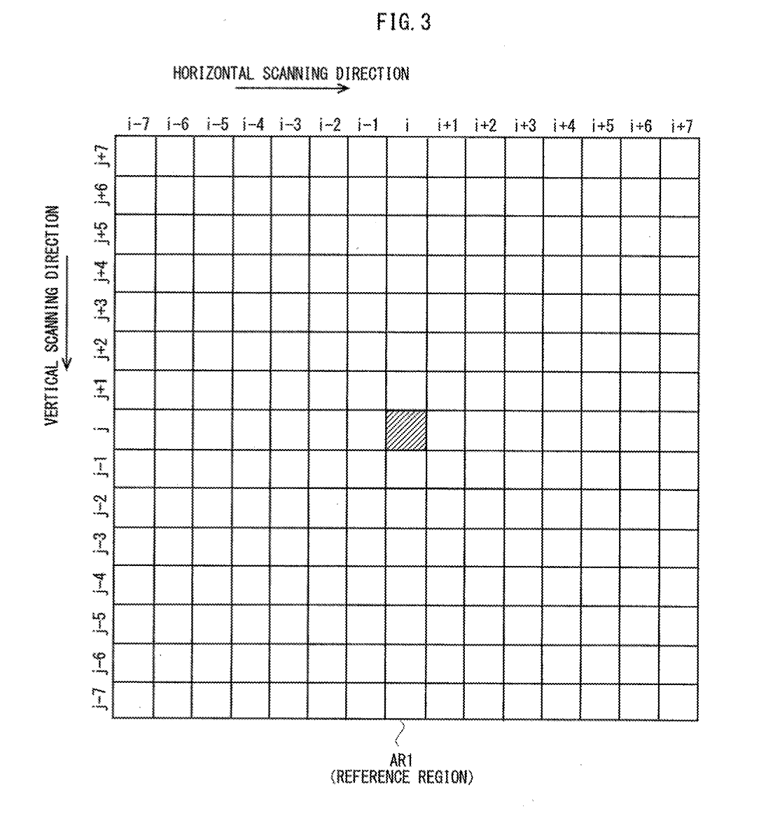

Step S13: The calculation unit 21 calculates standard deviations DEVr, DEVb, DEVrb of the respective color difference planes at the target pixel by using the color difference planes Cr, Cb, Crb calculated at the step S12. The calculation unit 21 of the present embodiment calculates the standard deviation by using the values of the respective color difference planes Cr, Cb, Crb of pixels existing at a reference region AR1 (first region) of which size is 15 pixels×15 pixels centering on the target pixel represented by oblique lines in FIG. 3. Note that the size of the reference region is set to be 15 pixels×15 pixels in the present embodiment, but it is preferable to be appropriately determined in accordance with a process ability of the CPU 1 and accuracy of the correction of the axial chromatic aberration. In case of the present embodiment, for example, it is preferred to set a size of one side within a range of 10 pixels to 30 pixels.

The calculation unit 21 calculates the standard deviations DEVr, DEVb, DEVrb of the respective color difference planes by using following expressions (7) to (9).

$$\begin{matrix}DEVr [ {k}^{′} ] ( i , j ) = \frac{1}{r \times r} {\sum }_{( x , y ) ∈ AR 1} ( Cr [ {k}^{′} ] ( x , y ) - \frac{{\sum }_{( l , m ) ∈ AR 1} Cr [ {k}^{′} ] ( l , m )}{r \times r} ) & ( 7 ) \\ DEVb [ {k}^{′} ] ( i , j ) = \frac{1}{r \times r} {\sum }_{( x , y ) ∈ AR 1} ( Cb [ {k}^{′} ] ( x , y ) - \frac{{\sum }_{( l , m ) ∈ AR 1} Cb [ {k}^{′} ] ( l , m )}{r \times r} ) & ( 8 ) \\ DEVrb [ {k}^{′} ] ( i , j ) = \frac{1}{r \times r} {\sum }_{( x , y ) ∈ AR 1} ( Crb [ {k}^{′} ] ( x , y ) - \frac{{\sum }_{( l , m ) ∈ AR 1} Crb [ {k}^{′} ] ( l , m )}{r \times r} ) & ( 9 )\end{matrix}$$

Here, the “k” is the blur index being an integer within a range of −N to N. The “r” represents the number of pixels of one side of the reference region, and “r”=15 pixels in the present embodiment. Besides, the (l, m) and the (x, y) each represent a pixel position in the reference region AR1.

Step S14: The determination unit 22 of the CPU 1 determines a color component of which sharpness is the highest at the target pixel (i, j) based on the standard deviations DEVr, DEVb, DEVrb of the respective color difference planes calculated at the step S13.

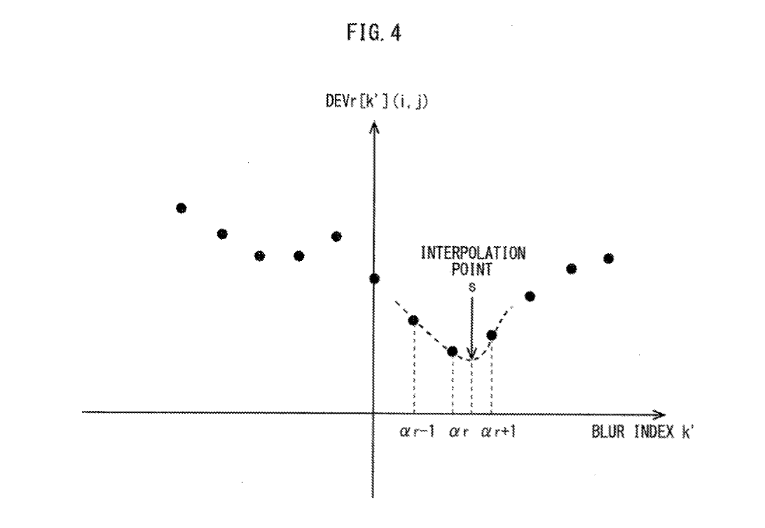

For example, the calculation unit 21 finds the blur index k′ giving the minimum standard deviation DEVr at the target pixel (i, j). FIG. 4 represents a distribution of the standard deviation DEVr [k′] at the target pixel (i, j). The calculation unit 21 finds the blur index k′=αᵣ of which standard deviation DEVr [k] becomes the minimum based on the distribution illustrated in FIG. 4. The determination unit 22 determines that the sharpness of the G component is higher at the target pixel (i, j) when the blur index αᵣ giving the minimum standard deviation is positive. On the other hand, the determination unit 22 determines that the sharpness of the R component is higher at the target pixel (i, j) when the blur index αᵣ giving the minimum standard deviation is negative.

The calculation unit 21 similarly performs processes in cases of the B component and the G component, the R component and the B component, and finds the blur indexes k′=α_{b} and k′=α_{rb} giving the minimum standard deviations DEVb, DEVrb. The determination unit 22 determines the color component of which sharpness is higher based on signs of the blur indexes α_{b} and α_{rb}.

Step S15: The CPU 1 judges whether or not the color component of which sharpness is the highest is determined at the target pixel (i, j) based on a result of the step S14. Namely, the determination unit 22 determines a color component as the color component of which sharpness is the highest at the target pixel (i, j) when the same color component is determined in two results among the results at the three color difference planes. The CPU 1 transfers to step S16 (YES side).

On the other hand, for example, when the determination unit 22 determines the R component, the G component, and the B component based on the respective standard deviations DEVr, DEVb, DEVrb of the respective color difference planes, the determination unit 22 is not able to determine one color component of which sharpness is the highest at the target pixel (i, j). In such a case, the CPU 1 judges that it is indefinite, and transfers to step S17 (NO side) without performing the correction processing of the axial chromatic aberration for the target image.

Step S16: The adjustment unit 23 of the CPU 1 adjusts the sharpness between the color components by each target pixel, and corrects the axial chromatic aberration based on the color component determined by each target pixel.

The calculation unit 21 finds a more accurate blur index “s” at the target pixel (i, j) based on, for example, the distribution of the standard deviation DEVr [k′] (i, j) of the color difference plane Cr between the R component and the G component as represented in FIG. 4. Namely, the blur index αᵣ minimizing the standard deviation DEVr found at the step S14 by the calculation unit 21 is not necessarily be the blur index rearly giving the minimum standard deviation DEVr as represented by a dotted line in FIG. 4. Accordingly, the calculation unit 21 applies the interpolation method for three points of the blur index αᵣ minimizing the calculated standard deviation DEVr and blur indexes αᵣ−1 and αᵣ+1 at both ends adjacent to the blur index αᵣ, and finds the more accurate blur index (interpolation point) “s”.

Here, the blur index “s” is represented by a following expression (10) when DEVr [αᵣ−1] (i, j)>DEVr [αᵣ+1] (i, j) in the distribution of the standard deviation DEVr [k′] (i, j).

blur index “s”=((αᵣ+1)+αᵣ)/2+(Devr[αᵣ+1](i,j)−DEVr[αᵣ](i,j))/2/a (10)

Here, a coefficient “a” is a gradient, and (DEVr [α_{r,}−1] (i, j)−DEVr [αᵣ] (i, j))/((αᵣ−1)−αᵣ).

On the other hand, the blur index “s” is represented by a following expression (11) when DEVr [αᵣ−1] (i, j)<DEVr [αᵣ+1] (i, j).

blur index “s”=((αᵣ−1)+αᵣ)/2+(Devr[αᵣ−1](i,j)−DEVr[αᵣ](i,j))/2/a (11)

Note that the gradient “a” is (DEVr [α_{r,}+1] (i, j)−DEVr [αᵣ] (i, j))/((αᵣ+1)−αᵣ).

The calculation unit 21 calculates a correction value G′ (i, j) by a publicly known weighting addition using Gαᵣ (i, j), G(αᵣ+1) (i, j) of the blur indexes αᵣ, αᵣ+1 together with the interpolation point “s”.

The following is an example when the G plane has the highest sharpness at the target pixel (i, j).

The adjustment unit 23 adjusts the sharpness of the R component at the target pixel (i, j) and corrects the axial chromatic aberration based on a following expression (12).

R′(i,j)=R0(i,j)+(G0(i,j)−G′(i,j)) (12)

The adjustment unit 23 similarly calculates a correction value G″ (i, j) as for the B component based on the distribution of the standard deviation DEVb of the color difference plane Cb between the B component and the G component, adjusts the sharpness of the B component at the target pixel (i, j) and corrects the axial chromatic aberration based on a following expression (13).

B′(i,j)=B0(i,j)+(G0(i,j)−G″(i,j)) (13)

Step S17: The CPU 1 judges whether or not the processes finish as for all of the pixels of the target image. The CPU 1 transfers to the step S12 (NO side) when it is judged that the processes do not finish as for all of the pixels, and performs the processes from the step S12 to the step S16 while setting a next pixel as the target pixel. On the other hand, the CPU 1 records an image made up of the color components R′, G, B′ at the storage unit 2 and displays the image on the output device 30 as a new image of which axial chromatic aberration is corrected when the CPU 1 judges that the processes finish as for all of the pixels. Then the CPU 1 finishes a series of the processes.

As stated above, in the present embodiment, the color component having the highest sharpness is determined based on the distribution of the standard deviation of each color difference plane, and the sharpness between the color components are adjusted, and therefore, it is possible to correct the axial chromatic aberration with high accuracy while avoiding the color loss at the target image.

### Second Embodiment

An image processing device according to a second embodiment of the present invention is similar to the image processing device according to the first embodiment illustrated in FIG. 1, and a computer 10 is operated as the image processing device. The same reference numerals are used to designate the same components in the present embodiment as the first embodiment, and detailed descriptions are not given.

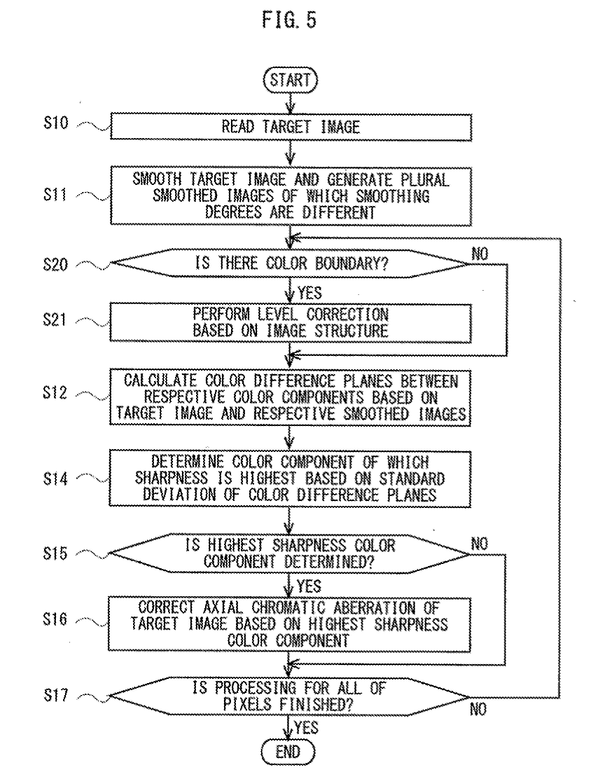

FIG. 5 illustrates a flowchart of operations of image processing by the computer 10 according to the present embodiment. In FIG. 5, the same step numbers are used to designate the same image processing in the first embodiment illustrated in FIG. 2, and the detailed descriptions are not given.

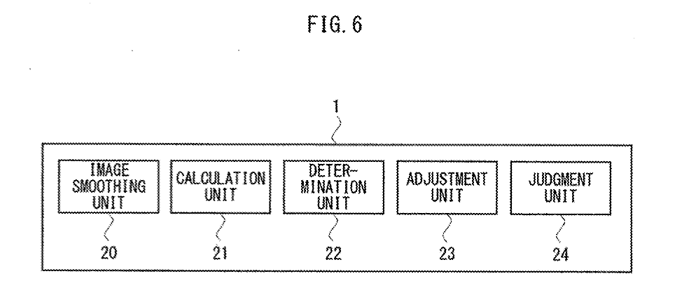

In the present embodiment, a point of the image processing by the computer 10 different from the first embodiment is that the CPU 1 operates as a judgment unit 24 together with the image smoothing unit 20, the calculation unit 21, the determination unit 22 and the adjustment unit 23 by the execution of the image processing program as illustrated in FIG. 6. As a result, step S20 in which the judgment unit 24 judges whether or not a color boundary exists at the target image and step S21 in which the calculation unit 21 performs a level correction to avoid an effect of the color boundary for the image processing are newly added between the step S11 and the step S12.

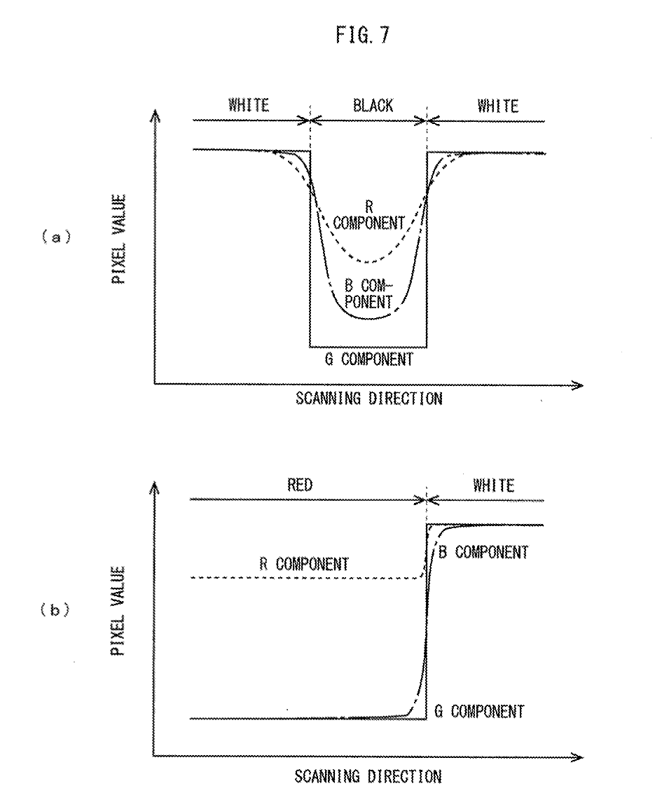

Here, the color boundary is briefly described. FIG. 7(a) represents distributions of the pixel values of the R component (dotted line), the G component (solid line), and the B component (broken line) in a scanning direction perpendicular to a black line when a target image is the one in which a subject of one black line on a white ground is image-captured. On the other hand, FIG. 7(b) represents distributions of the pixel values of the R component (dotted line), the G component (solid line), and the B component (broken line) in the scanning direction perpendicular to a color boundary when a target image is the one in which a subject having the color boundary made up of two colors of red and white is image-captured. Note that an imaging lens of a camera capturing the target images in FIG. 7 has the axial chromatic aberration and focuses at the G component.

As represented in FIG. 7(a), the G component finely reproduces the color structure, but the color structures of the R component and the B component are blurred caused by the axial chromatic aberration. A portion of the black line therefore bleeds into green or magenta. However, when the color structures between the color components match with each other, the calculation unit 21 is able to correct the axial chromatic aberrations for the R component and the B component by performing the image processing similar to the first embodiment. Namely, the correction processing of the axial chromatic aberration of the present embodiment assumes that the color structures between the color components match with each other.

On the other hand, as represented in FIG. 7(b), when the color structures of the respective color components differ largely at the color boundary, the above-stated assumption is not satisfied. Namely, the axial chromatic aberration of the R component cannot be corrected because it is impossible to approximate to the distribution (or the sharpness) of the R component even if the adjustment unit 23 smooths the G component of the target image having the color boundary with the blur index “s” as same as the first embodiment.

The computer 10 of the present embodiment therefore performs a process to avoid the effect resulting from the color boundary at the step S20 and the step S21.

At the step S20, the judgment unit 24 judges whether or not the color boundary exists at the target image at a region AR2 (second region) having a predetermined size centering on the target pixel. For example, the judgment unit 24 extracts pixel values at the maximum and at the minimum of each color component at the region AR2 of the target image. The calculation unit 21 finds a distribution width of the pixel value of each color component from the maximum and minimum pixel values of each color component. The judgment unit 24 compares the distribution widths of the respective color components, and judges whether or not there are color components of which difference between the maximum distribution width and the minimum distribution width becomes a threshold value δ or more. When the judgment unit 24 judges that there are the color components of which difference is the threshold value δ or more, it means that there is the color boundary, and the CPU 1 transfers to the step S21 (YES side). On the other hand, when the judgment unit 24 judges that there are no color components which difference becomes the threshold value δ or more, it means that the color boundary does not exist, then the CPU 1 transfers to the step S13 (NO side), and the processes similar to the first embodiment are performed.

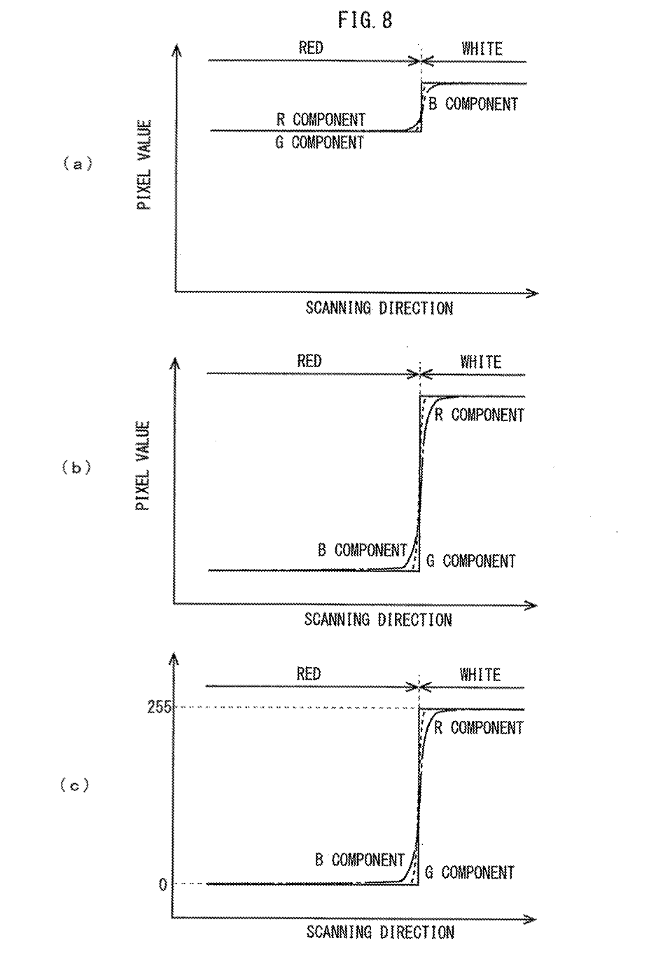

At the step S21, the calculation unit 21 performs the level correction for the target image in which it is judged that the color boundary exists at the step S20 and each color component at the region AR2 of each smoothed image. Namely, the calculation unit 21 performs the level correction in which the respective distribution widths of the pixels values of the color components represented in FIG. 7(b) are matched with the distribution width of any of the color components (FIG. 8(a), (b)). Otherwise, the calculation unit 21 may extend each pixel value of the color component to a predetermined distribution width (for example, “0” (zero) to 255) to perform the level correction (FIG. 8(c)). It is thereby possible to avoid the effect of the color boundary.

Note that the level corrected pixel values of target image and the respective smoothed images are used until the calculation unit 21 calculates the blur index “s” at the target pixel at the step S16.

Besides, the size of the region AR2 may be the same as the size of the reference region AR1, or may be different. Namely, the size of the region AR2 is preferable to be determined in accordance with the process ability of the CPU 1 and the required correction accuracy.

As stated above, in the present embodiment, the color component of which sharpness is the highest is determined based on the distribution of the standard deviation of each color difference plane, then the sharpness between the color components are adjusted, and therefore, it is possible to correct the axial chromatic aberration with high accuracy while avoiding the color loss at the target image.

Besides, it is possible to avoid the effect of the color boundary by matching the color structures of the respective color components by performing the level correction even when the color boundary exists.

### Third Embodiment

An image processing device according to a third embodiment of the present invention is similar to the image processing device according to the first embodiment illustrated in FIG. 1, and the computer 10 is operated as the image processing device. The same reference numerals are used to designate the same component of the present embodiment as the first embodiment, and detailed descriptions are not given.

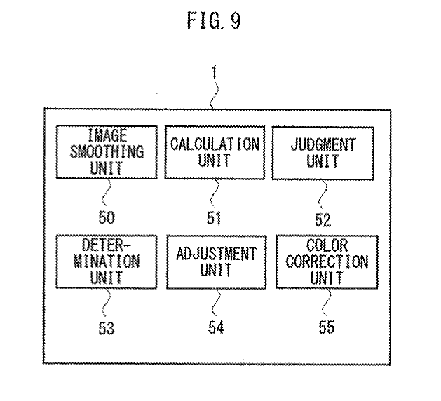

In the present embodiment, a point of the image processing by the computer 10 different from the first embodiment is that the CPU 1 operates as an image smoothing unit 50, a calculation unit 51, a judgment unit 52, a determination unit 53, an adjustment unit 54 and a color correction unit 55 by execution of the image processing program as illustrated in FIG. 9.

The image smoothing unit 50 performs the operation processes similar to the image smoothing unit 20 of the first embodiment, and the detailed description is not given.

The calculation unit 51 uses a target image and N pieces of smoothed images, and calculates values of a color difference plane (color difference) in accordance with a blur index and a standard deviation (dispersion) thereof from an absolute value of a difference between a color component of the target image and a color component of the smoothed image which is different from the color component of the target image at a pixel position of each pixel. The calculation unit 51 finds the blur index giving a minimum standard deviation at the pixel position by applying a publicly known interpolation method to a distribution of the standard deviation for the blur index at the pixel position of each pixel. Note that the calculation unit 51 of the present embodiment uses following expressions (14) to (19) instead of the expressions (1) to (6) to find the color difference planes.

Cr[−k](i,j)=|Rk(i,j)−G0(i,j)| (14)

Cr[k](i,j)=|R0(i,j)−Gk(i,j)| (15)

Cb[−k](i,j)=|Bk(i,j)−G0(i,j)| (16)

Cb[k](i,j)=|B0(i,j)−Gk(i,j)| (17)

Crb[−k](i,j)=|Rk(i,j)−B0(i,j)| (18)

The judgment unit 52 judges whether or not a color structure at the pixel position is a color boundary based on a value of the standard deviation between the color difference planes at each blur index. Namely, the color structures of the respective color components differ largely at the color boundary as represented in FIG. 7(b) as stated above, and therefore, the values of the standard deviation of the color difference between the respective color components also differ largely. The judgment unit 52 of the present embodiment judges whether or not there is a gap of a threshold value ε or more in the value of the standard deviation of the color difference between the respective color components at each of the calculated blur indexes to thereby judge whether or not the color structure at each pixel position is the color boundary. When the judgment unit 52 judges that the color structure at the pixel position is the color boundary, the correction of the axial chromatic aberration for the pixel at the pixel position is not performed in the present embodiment. It is thereby possible to suppress a color change generated by performing the correction processing of the axial chromatic aberration for the color boundary.

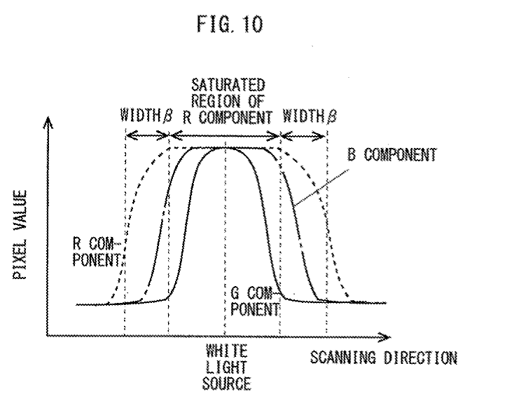

Further, the judgment unit 52 judges whether or not the color structure at the pixel position judged to be the color boundary is a color bleeding caused by a concentration difference at a periphery of a saturated region, for example, a purple fringing based on the distribution of the pixel value of each color component at the pixel position and at the periphery thereof. Here, the purple fringing means a purple color bleeding generated around a high brightness region in which the pixel value of each color component is saturated (saturated region) because light intensity is large such as a periphery of a light source such as a street light and reflected light of a surface of water. FIG. 10 represents distributions of pixel values of the R component (dotted line), the G component (solid line), and the B component (broken line) in a scanning direction passing through a center of a light source in a target image image-capturing a bright light source as an example of the purple fringing. As represented in FIG. 10, the saturated regions are different by each color component, the G component decreases first and the R component distributes to a widest range as getting away from the light source. The purple color bleeding appears caused by the distribution as stated above. The distribution of each color component as stated above is different from the case of the axial chromatic aberration represented in FIG. 7(a), and therefore, the judgment unit 52 judges that the purple fringing is the color boundary. However, a point in which the portion of the black line bleeds into green or magenta resulting from the axial chromatic aberration represented in FIG. 7(a) resembles to the purple fringing. Accordingly, the correction processing similar to the axial chromatic aberration is performed for the pixel position of the purple fringing in the present embodiment.

The judgment unit 52 finds the distribution of the pixel value of each color component at a peripheral region centering on the pixel position or at a whole of the target image, and finds the saturated region of the pixel value of each color component from the distribution as illustrated in FIG. 10. The judgment unit 52 extracts the saturated region of the color component distributed for the widest region (the R component in case of FIG. 10) and a region extended for widths β from ends of the saturated region as a purple fringing region. The judgment unit 52 judges whether or not the pixel position is included in the extracted purple fringing region, and judges whether or not the color structure of the pixel position is the purple fringing. The correction processing of the axial chromatic aberration is performed for the pixel at the pixel position judged to be the purple fringing as the target pixel.

The determination unit 53 determines the color component having the highest sharpness based on the blur index giving the minimum standard deviation at the pixel position which is judged not to be the color boundary and the pixel (target pixel) at the pixel position which is judged to be the purple fringing by the judgment unit 52.

The adjustment unit 54 performs the similar process operations as the adjustment unit 23 of the first embodiment, and adjusts the sharpness between the color components at the pixel position of the target pixel based on the color component having the highest sharpness determined by the determination unit 53.

The color correction unit 55 corrects the pixel value of each color component of the pixel of which sharpness is adjusted to turn to the same direction as a color difference before adjustment at a color difference space, and suppresses a color change generated by the correction processing of the axial chromatic aberration.

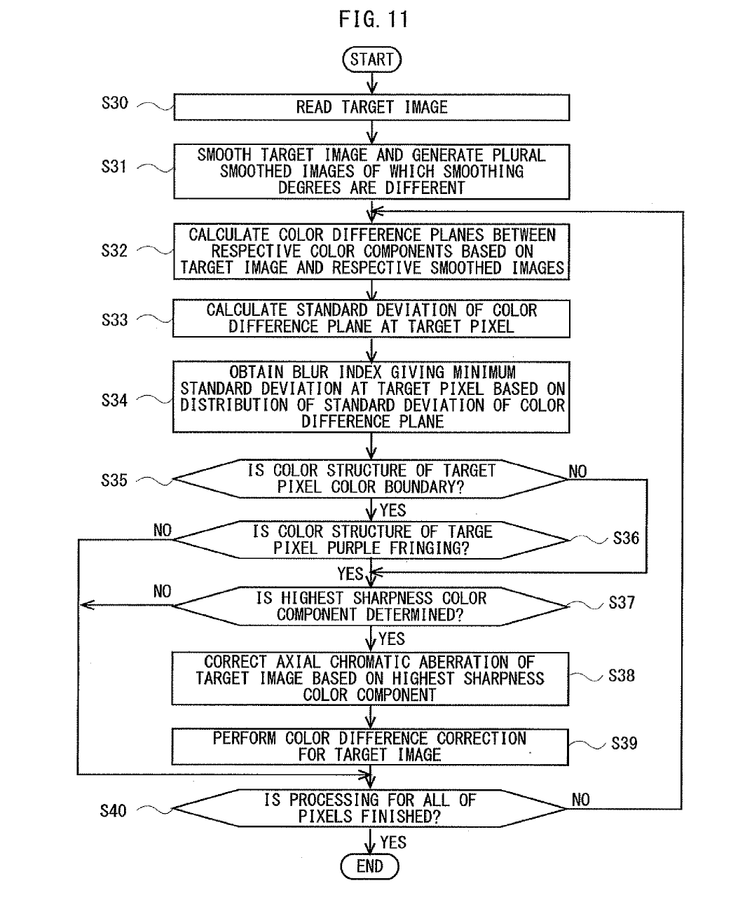

Next, image processing operations correcting the axial chromatic aberration by the computer 10 of the present embodiment are described with reference to a flowchart illustrated in FIG. 11.

The user instructs the start of the image processing program to the CPU 1 by inputting the command of the image processing program by using the input device 40, or by double-clicking the icon of the program displayed on the output device 30, and so on. The CPU 1 receives the instruction via the input and output I/F 3, reads and executes the image processing program stored at the storage unit 2. The CPU 1 starts processes from step S30 to step S40 in FIG. 11.

Step S30: The CPU 1 reads a target image of a correction object specified by the user via the input device 40.

Step S31: The image smoothing unit 50 of the CPU 1 smooths the read target image in accordance with the blur index of each Gaussian filter as same as the step S11 of the first embodiment, and generates N pieces of smoothed images.

Step S32: The calculation unit 51 of the CPU 1 calculates the color difference plane Cr between the R component and the G component, the color difference plane Cb between the B component and the G component, and the color difference plane Crb between the R component and the B component by using the target image, each smoothed image, and the expressions (14) to (19).

Step S33: The calculation unit 51 calculates the standard deviations DEVr, DEVb, DEVrb of the respective color difference planes at the target pixel (i, j) by each blur index by using the color difference planes Cr, Cb, Crb calculated at the step S32 and the expressions (7) to (9) as same as the step S13 of the first embodiment.

Step S34: The calculation unit 51 finds the blur index k′ giving the minimum standard deviation value at the target pixel (i, j) by each color difference plane by using the standard deviations DEVr, DEVb, DEVrb of the respective color difference planes calculated at the step S33. For example, the calculation unit 51 finds the blur index k′=αᵣ of which standard deviation becomes the minimum at the target pixel (i, j) based on the distribution of the standard deviation DEVr [k′] of the color difference plane Cr in accordance with the blur index illustrated in FIG. 4.

The circulation unit 51 performs the similar processes as for the cases of the color difference plane Cb and the color difference plane Crb, and finds the blur indexes k′=α_{b} and k′=α_{rb} giving the minimum standard deviations DEVb, DEVrb.

Step S35: The judgment unit 52 of the CPU 1 judges whether or not the color structure of the target pixel (i, j) has a hue of the color boundary based on the values of the standard deviations DEVr [k′], DEVb [k′], DEVrb [k′] of the respective color difference planes at the respective blur indexes k′ at the target pixel (i, j). The judgment unit 52 judges whether or not any one of the standard deviation values becomes a threshold value ε or more. Note that the threshold value ε of the present embodiment is set to be, for example, 50 when the target image is an image of 255 gradations. Note that the value of the threshold value ε is preferable to be determined in accordance with the pixel position of the target pixel, the reference region AR1, and so on, and for example, it is preferable to be set at the value within a range of 40 to 60.

The judgment unit 52 judges that the color structure of the target pixel (i, j) is the color boundary when there is the standard deviation value which is the threshold value ε or more, stores the pixel position of the target pixel to a not-illustrated working memory, and transfers to step S36 (YES side). On the other hand, the judgment unit 52 judges that the color structure of the target pixel (i, j) is not the color boundary when there is not the standard deviation value which is the threshold value ε or more, and transfers to step S37 (NO side) while setting the target pixel as an object pixel of the correction processing of the axial chromatic aberration.

Step S36: The judgment unit 52 judges whether or not the color structure of the target pixel (i, j) which is judged to be the color boundary at the step S35 is the purple fringing. The judgment unit 52 finds distributions thereof by using the target pixel (i, j), and peripheral pixels thereof, or the pixel values of the respective color components at the whole of the target image as illustrated in FIG. 7 and FIG. 10. The judgment unit 52 finds respective saturated regions in which the pixel value is saturated (the pixel value is 255 in case of a 255 gradation image) from the distribution of the pixel value by each color component. The judgment unit 52 sets a region in which the saturated region of which region is the widest among the sizes of the saturated regions of the respective color components, for example, the saturated region of the R component and a region extended for widths β from ends of the saturated region are added as the purple fringing region, and judges whether or not the target pixel is within the purple fringing region. Note that a value of the width β in the present embodiment is, for example, approximately 10 pixels. Incidentally, the size of the width β is preferable to be determined in accordance with the process ability of the CPU 1, the accuracy of the correction processing of the axial chromatic aberration, and a degree of decreasing from a saturated state in each color component.

The judgment unit 52 judges that the color structure of the target pixel is the purple fringing when the target pixel is within the purple fringing region, and records the pixel position of the target pixel to the working memory (not-illustrated). The judgment unit 52 transfers to the step S37 (YES side) while setting the target pixel as the object pixel of the correction processing of the axial chromatic aberration. On the other hand, when the target pixel is out of the purple fringing region, the judgment unit 52 judges that the color structure of the target pixel is the color boundary, does not perform the correction processing of the axial chromatic aberration for the target pixel, and transfers to step S40 (NO side).

Step S37: The determination unit 53 determines the color component having the highest sharpness at the target pixel (i, j) based on blur indexes αᵣ, α_{b}, α_{rb} of the respective color difference planes found at the step S34. The determination unit 53 determines that the G component has the higher sharpness at the target pixel (i, j) when the blur index αᵣ giving the minimum standard deviation is positive. On the other hand, the determination unit 53 determines that the R component has the higher sharpness at the target pixel (i, j) when the blur index αᵣ giving the minimum standard deviation is negative. The determination unit 53 determines the color component having the higher sharpness based on the signs thereof as for each of the blur indexes α_{b} and α_{rb}.

The determination unit 53 judges whether or not the color component having the highest sharpness is determined at the target pixel (i, j) based on the above-stated result. Namely, when the same color component is determined in two results among the results at the three color difference planes, the determination unit 53 determines that the color component is the color component having the highest sharpness at the target pixel (i, j), and transfers to the step S38 (YES side).

On the other hand, for example, when the R component, the G component, the B component are each determined based on the blur indexes αᵣ, α_{b}, α_{rb} of the respective color difference planes, the determination unit 53 is not able to determine one color component having the highest sharpness at the target pixel (i, j). In such a case, the determination unit 53 judges that it is indefinite, and transfers to step S40 (NO side) without performing the correction processing of the axial chromatic aberration for the target pixel. Note that the sharpness of the respective color components determined by each color difference plane are compared to determine the color component having the highest sharpness.

Step S38: The adjustment unit 54 of the CPU 1 adjusts the sharpness between the color components of the target pixel (i, j) based on the color component determined at the step S37, and corrects the axial chromatic aberration.

The calculation unit 51 finds a blur index (interpolation point) “s” giving the minimum standard deviation value in a true sense at the target pixel (i, j) based on, for example, the distribution of the standard deviation DEVr of the color difference plane Cr illustrated in FIG. 4 by using the expressions (10) to (11). The calculation unit 51 calculates the correction value G′ (i, j) by the publicly known weighting addition using Gαᵣ (i, j), G(αᵣ+1) (j, j) of the blur indexes αᵣ, αᵣ+1 together with the found interpolation point “s”.

The adjustment unit 54 adjusts the sharpness of the R component and the B component at the target pixel (i, j) based on, for example, the expressions (12) to (13) and corrects the axial chromatic aberration.

Step S39: The color correction unit 55 of the CPU 1 performs a color difference correction for the pixel value of each color component of the target pixel to which the correction processing of the axial chromatic aberration is performed.

Namely, it is because there is a case when a direction of a color difference component at a color space of brightness and color difference particularly changes largely in the pixel value of each color component of the target pixel to which the correction processing of the axial chromatic aberration is performed at the step S38 when it is compared with the pixel value before correction. The color change thereby occurs at the target pixel (i, j). Accordingly, in the present embodiment, the color correction unit 55 corrects such that the color difference component after correction at the target pixel becomes the same direction as the color difference component before correction at the space of the brightness and color difference to suppress occurrence of the color change.

Specifically, the color correction unit 55 converts the pixel values of the respective color components of the target pixel before and after correction of a pixel value (R′, G, B′) in RGB into a brightness component of YCrCb and a color difference component (Y′, Cr′, Cb′) by applying publicly known conversion processing. Here, the brightness component before correction and the color difference component are set to be (Y0, Cr0, Cb0). The color correction unit 55 corrects the direction of the color difference component of the target pixel into the direction before correction by a following expression (20). Note that in the present embodiment, the brightness component Y′ is not corrected.

$$( {Cr}^{″} , {Cb}^{″} ) = \frac{{L}^{′}}{L} ( Cr 0 , Cb 0 ) \\ L = \sqrt{Cr {0}^{2} + Cb {0}^{2}} , {L}^{′} = \sqrt{{Cr}^{′2} + {Cb}^{′2}} \qquad ( 20 )$$

The color correction unit 55 applies the above-stated publicly known conversion processing again to convert the brightness component and the color difference component (Y′, Cr″, Cb″) of the target pixel after the color difference correction into a pixel value (R₁, G₁, B₁) in RGB. The color correction unit 55 sets the pixel value (R₁, G₁, B₁) as a pixel value of the target pixel (i, j).

Step S40: The CPU 1 judges whether or not the processes finish for all of the pixels in the target image. The CPU 1 transfers to the step S32 (NO side) when it is judged that the processes do not finish as for all of the pixels, and performs the processes from the step S32 to the step S39 while setting a next pixel as the target pixel. On the other hand, the CPU 1 records the image of which axial chromatic aberration is corrected to the storage unit 2 and displays on the output device 30 when it is judged that the processes finish as for all of the pixels. The CPU 1 finishes a series of processes.

As stated above, in the present embodiment, the color structure at each pixel position is judged based on the value of the standard deviation of each color difference plane, and thereby, it is possible to perform the correction of the axial chromatic aberration with high accuracy.

Besides, it is possible to suppress the occurrence of the color change and the color loss by not performing the correction processing of the axial chromatic aberration for the target pixel which is judged to be the color boundary.

Further, the pixel value after correction of the target pixel is corrected into the direction of the color difference component which is held by the pixel value before correction at the color difference space, and thereby, it is possible to perform the correction of the axial chromatic aberration with higher accuracy while suppressing the color change and the color loss.

### Fourth Embodiment

An image processing device according to a fourth embodiment of the present invention is the same as the image processing device according to the third embodiment. Accordingly, the computer 10 illustrated in FIG. 1 is set to be the image processing device according to the present embodiment, and the same reference numerals are used to designate the same component, and detailed descriptions are not given.

Note that points of the computer 10 of the present embodiment different from the third embodiment are that (1) the calculation unit 51 calculates the values of the color difference planes (color differences) in accordance with the blur indexes by using the target image, the N pieces of smoothed images, and the expressions (1) to (6), (2) the judgment unit 52 calculates the difference of the values of the standard deviations between the color difference planes at the respective blur indexes, and judges whether or not the color structure at the pixel position is the color boundary based on an absolute value.

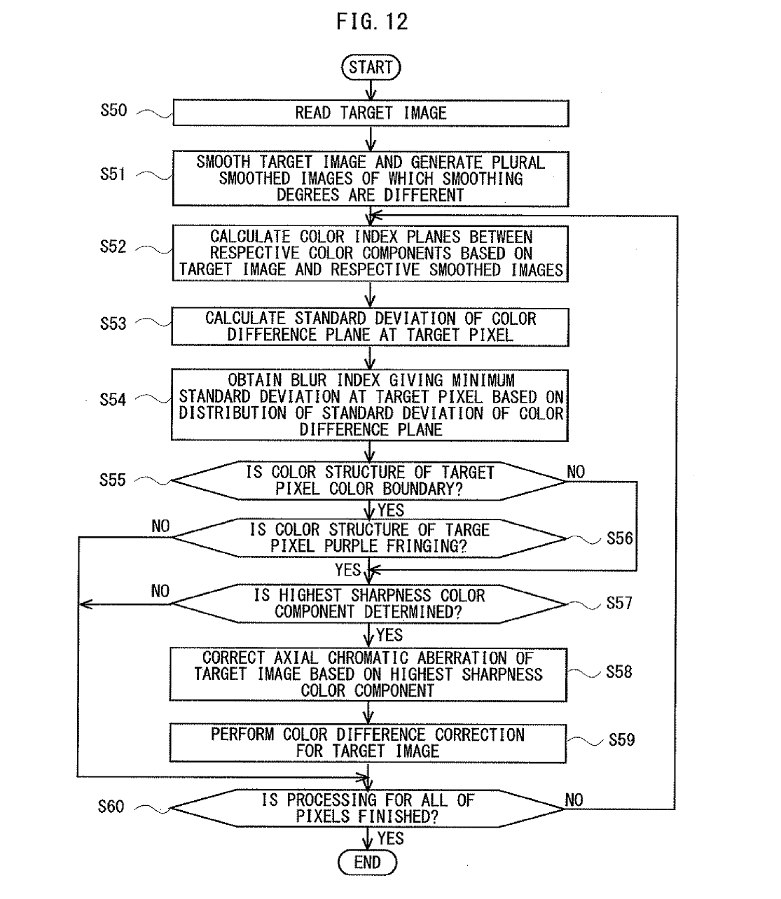

Next, the operations of the image processing correcting the axial chromatic aberration by the computer 10 of the present embodiment are described with reference to a flowchart illustrated in FIG. 12.

The user instructs the start of the image processing program to the CPU 1 by inputting the command of the image processing program by using the input device 40, or by double-clicking the icon of the program displayed on the output device 30, and so on. The CPU 1 receives the instruction via the input and output I/F 3, reads and executes the image processing program stored at the storage unit 2. The CPU 1 starts processes from step S50 to step S60 in FIG. 12.

Step S50: The CPU 1 reads a target image of a correction object specified by the user via the input device 40.

Step S51: The image smoothing unit 50 of the CPU 1 smooths the read target image in accordance with the blur index of each Gaussian filter as same as the step S31 of the third embodiment, and generates N pieces of smoothed images.

Step S52: The calculation unit 51 of the CPU 1 calculates the color difference plane Cr between the R component and the G component, the color difference plane Cb between the B component and the G component, and the color difference plane Crb between the R component and the B component by using the target image, each smoothed image, and the expressions (1) to (6).

Step S53: The calculation unit 51 calculates the standard deviations DEVr, DEVb, DEVrb of the respective color difference planes at the target pixel (i, j) by each blur index by using the color difference planes Cr, Cb, Crb calculated at the step S52 based on the expressions (7) to (9) as same as the step S33 of the third embodiment.

Step S54: The calculation unit 51 finds the blur indexes k′ (=αᵣ, α_{b}, α_{rb}) giving the minimum standard deviation values at the target pixel (i, j) by each color difference plane by using the standard deviations DEVr, DEVb, DEVrb of the respective color difference planes calculated at the step S53 as same as the step S34 of the third embodiment.

Step S55: The judgment unit 52 of the CPU 1 finds the differences of the standard deviations of the respective color difference planes at the respective blur indexes k′, DEVr [k′]−DEVb [k′], DEVb [k′]−DEVrb [k′], DEVr [k′]−DEVrb [k′] at the target pixel (i, j), and judges whether or not the color structure of the target pixel (i, j) has a hue of the color boundary based on absolute values of the differences. The judgment unit 52 judges whether or not any one of the absolute values of the differences of the standard deviations becomes a threshold value ε or more. Note that the threshold value ε of the present embodiment is set to be, for example, 50 when the target image is an image of 255 gradations. Note that the value of the threshold value ε is preferable to be determined in accordance with the gradation of the target image, the pixel position of the target pixel, the reference region AR1 and so on, and for example, it is preferable to be set at the value within a range of 40 to 60.

The judgment unit 52 judges that the color structure of the target pixel (i, j) is the color boundary when there is the absolute value of the difference of the standard deviations which is the threshold value ε or more, records the pixel position of the target pixel to a not-illustrated working memory, and transfers to step S56 (YES side). On the other hand, the judgment unit 52 judges that the color structure of the target pixel (i, j) is not the color boundary when there is not the absolute value of the difference of the standard deviations which is the threshold value ε or more, and transfers to step S57 (NO side) while setting the target pixel as an object pixel of the correction processing of the axial chromatic aberration.

Step S56: The judgment unit 52 judges whether or not the color structure of the target pixel (i, j) which is judged to be the color boundary at the step S55 is the purple fringing as same as the step S36 of the third embodiment.

The judgment unit 52 judges that the color structure of the target pixel is the purple fringing when the target pixel is within the purple fringing region, and records the pixel position of the target pixel to the working memory (not-illustrated). The judgment unit 52 transfers to the step S57 (YES side) while setting the target pixel as the object pixel of the correction processing of the axial chromatic aberration. On the other hand, when the target pixel is out of the purple fringing region, the judgment unit 52 judges that the color structure of the target pixel is the color boundary, does not perform the correction processing of the axial chromatic aberration for the target pixel, and transfers to step S60 (NO side).

Step S57: The determination unit 53 determines the color component having the highest sharpness at the target pixel (i, j) based on blur indexes αᵣ, α_{b}, α_{rb} of the respective color difference planes found at the step S54 as same as the step S37 of the third embodiment. The determination unit 53 transfers to step S58 (YES side) when it is possible to determine the color component having the highest sharpness at the target pixel (i, j).

On the other hand, the determination unit 53 transfers to step S60 (NO side) without performing the correction processing of the axial chromatic aberration for the target pixel when it is not possible to determine one color component having the highest sharpness at the target pixel (i, j).

Step S58: The adjustment unit 54 of the CPU 1 adjusts the sharpness between the color components of the target pixel (i, j) based on the determined color component at the step S57, and corrects the axial chromatic aberration as same as the step S38 of the third embodiment.

Step S59: The color correction unit 55 of the CPU 1 performs the color difference correction for the pixel values of the respective color components of the target pixel to which the correction processing of the axial chromatic aberration is performed by using the expression (20) as same as the step S39 of the third embodiment.

Step S60: The CPU 1 judges whether or not the processes finish for all of the pixels in the target image. The CPU 1 transfers to the step S52 (NO side) when it is judged that the processes do not finish as for all of the pixels, and performs the processes from the step S52 to the step S59 while setting a next pixel as the target pixel. On the other hand, the CPU 1 records the image of which axial chromatic aberration is corrected to the storage unit 2 and displays on the output device 30 when it is judged that the processes finish as for all of the pixels. The CPU 1 finishes a series of processes.

As stated above, in the present embodiment, the color structure at each pixel position is judged based on the differences of the standard deviations of the respective color difference planes, and thereby, it is possible to perform the correction of the axial chromatic aberration with high accuracy.

Besides, it is possible to suppress the occurrence of the color change and the color loss by not performing the correction processing of the axial chromatic aberration for the target pixel which is judged to be the color boundary.

Further, the pixel value after correction of the target pixel is corrected into the direction of the color difference component which is held by the pixel value before correction at the color difference space, and thereby, it is possible to perform the correction of the axial chromatic aberration with higher accuracy while suppressing the color change and the color loss.

<<Supplementary Items to the Embodiment>>

(1) The image processing device of the present invention is enabled by executing the image processing program by the computer 10, but the present invention is not limited thereto. It is applicable for a program and a medium recording the program to enable the processes at the image processing device according to the present invention by the computer 10.

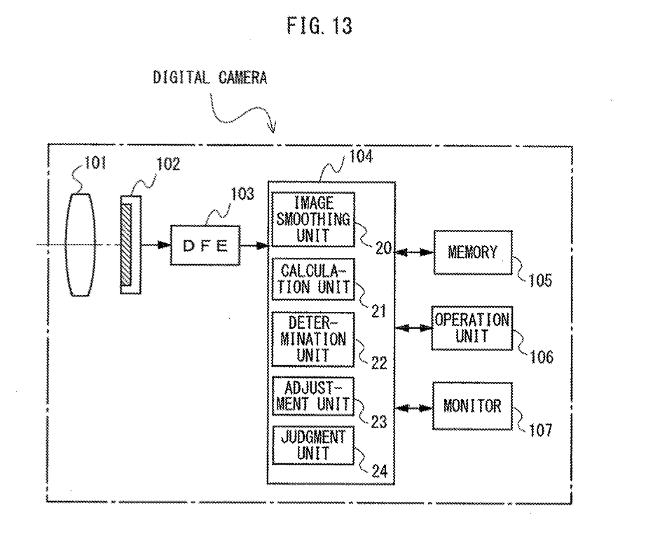

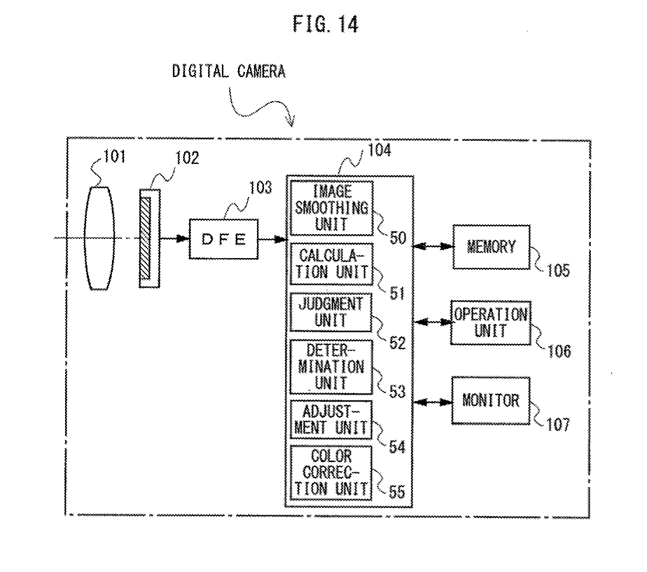

Besides, it is applicable for a digital camera as illustrated in FIG. 13 and FIG. 14 having the image processing program of the present invention. Note that in the digital camera illustrated in FIG. 13 and FIG. 14, it is preferable that an imaging unit is made up of an imaging sensor 102 and a DFE 103 being a digital front-end circuit performing a signal process such as an A/D conversion of an image signal input from the imaging sensor 102 and a color correction processing.

Besides, when the digital camera is operated as the image processing device of the present invention, a CPU 104 may enable respective processes of the image smoothing unit 20, the calculation unit 21, the determination unit 22, the adjustment unit 23, and the judgment unit 24, or the image smoothing unit 50, the calculation unit 51, the judgment unit 52, the determination unit 53, the adjustment unit 54, and the color correction unit 55 by means of software, or may enable the respective processes by means of hardware by using ASIC.

(2) In the above-stated embodiments, the image smoothing units 20, 50 generate the N pieces of smoothed images from the target image by using the plural Gaussian filters, but the present invention is not limited thereto. For example, when a point spread function (PSF) of an optical system such as an imaging lens 101 of the digital camera as illustrated in FIG. 13 and FIG. 14 is obtained, the image smoothing units 20, 50 may generate the smoothed images by using the PSF instead of using the Gaussian filter.

(3) In the above-stated embodiments, the correction of the axial chromatic aberration of the target image is performed based on the color difference plane Cr between the R component and the G component, the color difference plane Cb between the B component and the G component, and the color difference plane Crb between the R component and the B component, but the present invention is not limited thereto. For example, the correction of the axial chromatic aberration of the target image may be performed based on the two color difference planes among the three color difference planes. It is thereby possible to enable speeding up of the correction processing.

(4) In the above-stated embodiments, the target image includes the pixel value of the R component, the G component, and the B component at each pixel, but the present invention is not limited thereto. For example, each pixel of the target image may include the color components of two, or four or more.

Besides, when color filters of R, G, B are arranged in accordance with a publicly known Bayer array at each pixel of a light-receiving surface of the imaging sensor 102 of the digital camera illustrated in FIG. 13 and FIG. 14, the present invention is applicable for a RAW image image-captured by the imaging sensor 102.

(5) In the above-stated third embodiment and fourth embodiment, the color correction unit 55 performs the color difference correction for all of the target pixels to which the correction processing of the axial chromatic aberration is performed, but the present invention is not limited thereto. The color correction unit 55 may be set not to perform the color difference correction when a value of a size L′ of the color difference component after correction of the target pixel is smaller than a value of a size L of the color difference component before correction.

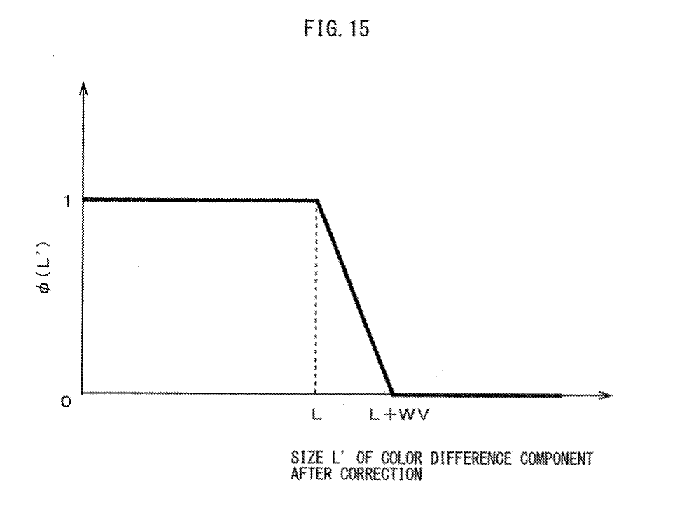

Besides, the color correction unit 55 may make an output factor of the color difference component after correction small based on a following expression (22) modifying the expression (20) by using a correction output factor φ (L′) defined by FIG. 15 and a following expression (21) when the size L′ of the color difference component after correction is larger than the size L of the color difference component before correction (a predetermined size).

$$\begin{matrix}φ ( {L}^{′} ) = clip ( \frac{L - {L}^{′} + WV}{WV} , 0 , 1 ) & ( 21 ) \\ ( {Cr}^{″} , {Cb}^{″} ) = ( 1 - φ ( {L}^{′} ) ) \cdot ( Cr 0 , Cb 0 ) + φ ( {L}^{′} ) \cdot \frac{{L}^{′}}{L} ( Cr 0 , Cb 0 ) & ( 22 )\end{matrix}$$

It is thereby possible to more accurately suppress the occurrence of the color change. Note that the function clip (V, U₁, U₂) means that a value of a parameter V clips to a lower limit value U₁ or an upper limit value U₂ when the value of the parameter V is a value out of a range between the lower limit value U₁ and the upper limit value U₂. Note that a coefficient WV represents a width in which the correction output factor φ (L′) is changed from the upper limit value U₂ (=1) to the lower limit value U₁ (=“0” (zero)), and for example, the coefficient WV is set to be a value of 5 to 10 when it is the 255 gradation image. Incidentally, the value of the coefficient WV is preferable to be appropriately set in accordance with a required degree of suppression of the color change and so on.

(6) In the above-stated third embodiment and fourth embodiment, the correction processing of the axial chromatic aberration is not performed when the color structure of the target pixel (i, j) is the color boundary, but the present invention is not limited thereto. For example, the processes from the step S37 to the step S39 or from the step S57 to the step S59 may be performed for the target pixel (i, j) positioning at the color boundary. Note that it is preferable that the adjustment unit 54 performs the correction by using following expressions (23) and (24) instead of the expressions (12) and (13) at the step S38 or the step S58. In this case, the color correction unit 55 is preferable to perform the color difference correction also for the target pixel judged to be the color boundary at the step S39 or the step S59.

R′(i,j)=R0(i,j)+γ×(G0(i,j)−G′(i,j) (23)

B′(i,j)=B0(i,j)+γ×(G0(i,j)−G″(i,j) (24)

Here, it is preferable that a coefficient γ is set to be a value of 0.1 to 0.2 or less not to be largely affected by the color boundary. Note that the value of the coefficient γ is preferable to be determined in accordance with the value of the standard deviation or the absolute value of the difference of the standard deviations and so on of each color difference plane at each blur index at the target pixel (i, j). Besides, the coefficient γ may be set by each color component.

It is thereby possible to avoid an effect caused by discontinuity of the correction processing method particularly in a vicinity of a boundary of the purple fringing region and to keep spatial continuity of gradation of the image. Note that the adjustment unit 54 may apply a publicly known smoothing processing to keep the spatial continuity of the gradation of the image.

(7) In the above-stated third embodiment and fourth embodiment, the judgment unit 52 performs the judgment of whether or not the color structure of the target pixel (i, j) is the color boundary by using one threshold value e, but the present invention is not limited thereto. For example, the judgment unit 52 may perform the judgment by using two threshold values ε₁ and ε₂ (ε₁<ε₂). In this case, it is preferable to use the expressions (23) and (24) instead of the expressions (12) and (13).

For example, when the value of the standard deviation or the absolute value of the difference of the standard deviations is the threshold value ε₁ or less, and it is judged that the color structure of the target pixel is not the color boundary by the judgment unit 52, the adjustment unit 54 sets that the coefficient γ=1, and performs the correction processing of the axial chromatic aberration for the target pixel (i, j). On the other hand, when the value of the standard deviation or the absolute value of the difference of the standard deviations is the threshold value ε₂ or more, and it is judged that the color structure of the target pixel is the color boundary, the adjustment unit 54 sets that the coefficient γ=“0” (zero) or a small value of 0.1 to 0.2 or less, and performs the correction processing of the axial chromatic aberration for the target pixel (i, j). When the value of the standard deviation or the absolute value of the difference of the standard deviations is between the threshold value ε₁ and the threshold value ε₂, the judgment unit 52 judges that the color structure of the target pixel is indefinite, the adjustment unit 54 sets the coefficient γ to the value between 1 to “0” (zero) in accordance with, for example, a size of the value of the standard deviation or the absolute value of the difference of the standard deviations and sizes of the threshold values ε₁ and ε₂, and performs the correction processing of the axial chromatic aberration for the target pixel. Note that in this case, the color correction unit 55 is preferable to perform the color difference correction processing for all of the target pixels at the step S39 or the step S59.

It is thereby possible to avoid the effect caused by the discontinuity of the correction processing method particularly in the vicinity of the boundary of the purple fringing region and to keep the spatial continuity of the gradation of the image. Note that the adjustment unit 54 may apply a publicly known smoothing processing to keep the spatial continuity of the gradation of the image.

(8) In the above-stated third embodiment and fourth embodiment, the judgment unit 52 finds the purple fringing region based on the distributions of the pixel values of the respective color components of the target pixel (i, j) and the peripheral pixels, to judge whether or not the color structure of the target pixel (i, j) is the purple fringing, but the present invention is not limited thereto. For example, the judgment unit 52 may first find the region where the brightness component is saturated as the saturated region based on the brightness component of the target image when the purple fringing region is found.

Incidentally, a region having a size of approximately several pixels caused by shot noise and so on is included in the found saturated regions. Accordingly, the judgment unit 52 reduces the saturated region by deleting a peripheral region for approximately one pixel width from each of the found saturated regions by using, for example, a publicly known method. The saturated region having the size of approximately several pixels caused by the shot noise and so on is thereby removed. The judgment unit 52 expands the reduced saturated region by adding a peripheral region of, for example, approximately for one pixel width. The judgment unit 52 performs the expansion processing for plural times until a region of approximately the width β is finally added to the saturated region to find the purple fringing region.

Note that the judgment unit 52 may apply a publicly known noise removal processing to remove the saturated region having the size of approximately several pixels caused by the shot noise and so on.

(9) In the above-stated first embodiment, second embodiment, and fourth embodiment, the calculation units 21, 51 find the color difference planes Cr, Cb, Crb as differences of the pixel values of the different color components by using the expressions (1) to (6), but the present invention is not limited thereto. The color difference planes Cr, Cb, Crb may be the absolute values of the differences of the pixel values of the different color components, or may be values in which the differences are squared.

(10) In the above-stated third embodiment, the calculation unit 51 finds the color difference planes Cr, Cb, Crb as the absolute values of the differences of the pixel values of different color components by using the expressions (14) to (19), but the present invention is not limited thereto. The color difference planes Cr, Cb, Crb may be just values of the differences of the pixels values of the different color components, or may be values in which the differences are squared.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1. An image processing device, comprising:
an image smoothing unit smoothing a target image having pixel values which include a plurality of color components with a different plurality of smoothing degrees and generating a plurality of smoothed images;
a calculation unit obtaining, at each pixel position of the target image, color differences being differences between a pixel value of a predetermined color component of the target image and pixel values of a color component of each of the smoothed images in which the color component is different from the predetermined color component, and calculating dispersions of the color differences being obtained;
a determination unit comparing sharpness of each of the color components of the target image based on the dispersions of the color differences and determining a color component having the highest sharpness; and
an adjustment unit adjusting the sharpness of at least one of the color components of the target image based on the color component having the highest sharpness.
